(19) United States
(12) Patent Application Publication
(10) Pub. No.: US 2017/0371704 A1
(43) Pub. Date: Dec. 28, 2017

(54) PROGRAM INFORMATION GENERATING SYSTEM, METHOD, AND PROGRAM PRODUCT

(71) Applicant: Kabushiki Kaisha Toshiba, Minato-ku (JP)

(72) Inventors: Mayuko KOEZUKA, Ota (JP); Hidenori MATSUZAKI, Fuchu (JP); Nobuaki TOJO, Tachikawa (JP); Akira KURODA, Yokohama (JP); Tatsuaki WATANABE, Kamakura (JP)

(73) Assignee: Kabushiki Kaisha Toshiba, Minato-ku (JP)

(21) Appl. No.: 15/681,523

(22) Filed: Aug. 21, 2017

Related U.S. Application Data
(63) Continuation of application No. PCT/JP2015/071811, filed on Jul. 31, 2015.

(51) Int. Cl. G06F 9/48

(52) U.S. Cl. CPC G06F 9/4812

(57) ABSTRACT

A program information generating system includes circuitry configured to acquire a program including a non-interruption instruction code and an interruption instruction code, and action information indicating an order of execution of the non-interruption instruction code and the interruption instruction code, determine an action interruption position representing a position where interruption has occurred in the action information based on the interruption instruction code and the action information, determine a program interruption position representing a position where interruption has occurred in the program based on the non-interruption instruction code and the action interruption position, and generate program interruption position information for specifying the program interruption position.

### CROSS-REFERENCE TO RELATED APPLICATIONS

This application is based upon and claims the benefit of priority from PCT Application No. PCT/JP2015/071811, filed on Jul. 31, 2015; the entire contents of which are incorporated herein by reference.

### FIELD

Embodiments described herein relate generally to a program information generating system, method, and program product.

### BACKGROUND

Systems for generating information indicating the status of execution of a program (software) are used for development, inspection, and the like of the program systems include those that display, on a time axis, order and the results of execution of a program executed in a simulation in which the timing of execution of non-interruption processing and the timing of interruption processing are displayed on the same time axis.

Conventional systems display the position where interruption processing has occurred on a time axis used for displaying results of a simulation. The systems can specify the position of interruption at the level of action information (tracing information) of the program but cannot specify the position at the level of instruction codes constructing the program.

### BRIEF DESCRIPTION OF THE DRAWINGS

FIG. 1 is a drawing illustrating a functional configuration of a program information generating system in a first embodiment.

FIG. 2 is a drawing illustrating a hardware configuration of the program information generating system.

FIG. 3 is a drawing illustrating an inner configuration of each of an information processing terminal and a server.

FIG. 4 is a flowchart illustrating a processing flow performed by the program information generating system.

FIG. 5 is a drawing illustrating a source code and a program in the first embodiment.

FIG. 6 is a drawing illustrating a program and action information in the first embodiment.

FIG. 7 is a drawing illustrating a method of determining an action interruption position in the first embodiment.

FIG. 8 is a drawing illustrating a method of determining a program interruption position in the first embodiment.

FIG. 9 is a drawing illustrating program interruption position information of a first example in the first embodiment.

FIG. 10 is a drawing illustrating program interruption position information of a second example in the first embodiment.

FIG. 11 is a drawing illustrating a functional configuration of a program information generating system in a second embodiment.

FIG. 12 is a drawing illustrating a program and action information in the second embodiment.

FIG. 13 is a drawing illustrating a functional configuration of a program information generating system in a third embodiment.

FIG. 14 is a drawing illustrating program interruption position information generated by a generating unit in the third embodiment.

FIG. 15 is a drawing illustrating a display image of a first example in the third embodiment.

FIG. 16 is a drawing illustrating a display image of a second example in the third embodiment.

FIG. 17 is a drawing illustrating a display image of third example in the third embodiment.

FIG. 18 is a drawing illustrating a display image of a fourth example in the third embodiment.

FIG. 19 is a drawing illustrating a display image of a fifth example in the third embodiment.

FIG. 20 is a drawing illustrating a program, action information, and program interruption position information in a fourth embodiment.

FIG. 21 is a drawing illustrating a display image of a first example in the fourth embodiment.

FIG. 22 is a drawing illustrating a display image of a second example in the fourth embodiment.

FIG. 23 is a drawing illustrating a program, action information, and program interruption position information in a fifth embodiment.

FIG. 24 is a drawing illustrating a display image of a first example in the fifth embodiment.

FIG. 25 is a drawing illustrating a display image of second example in the fifth embodiment.

FIG. 26 is a drawing illustrating a program, action information, and program interruption position information in a sixth embodiment.

FIG. 27 is a drawing illustrating a display image in the sixth embodiment.

### DETAILED DESCRIPTION

### First Embodiment

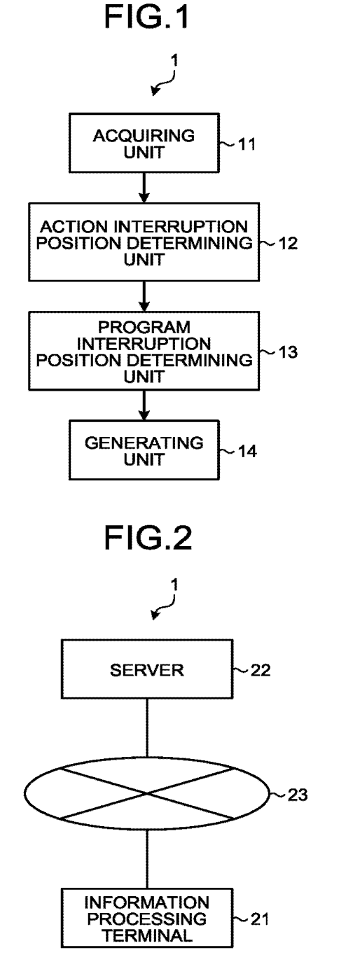

FIG. 1 is a drawing illustrating a functional configuration of a program information generating system 1 in a first embodiment. The program information generating system 1 includes an acquiring unit 11, an action interruption position determining unit 12 (a first determining unit), a program interruption position determining unit 13 (a second determining unit), and a generating unit 14.

FIG. 2 is a drawing illustrating a hardware configuration of the program information generating system 1. The program information generating system 1 in this example includes an information processing terminal 21, a server 22, and a network 23. Examples of the information processing terminal 21 may include a personal computer (PC), a tablet, and a smartphone of a user. Examples of the server 22 may include a server computer managed by an administrator of the program information generating system 1. The information processing terminal 21 and the server 22 are connected with each other through the network 23 such as the Internet and a local area network (LAN). Although FIG. 2 illustrates each one of the information processing terminal 21 and the server 22, a plurality of information processing terminals 21 and a plurality of servers 22, or a combination thereof can be included.

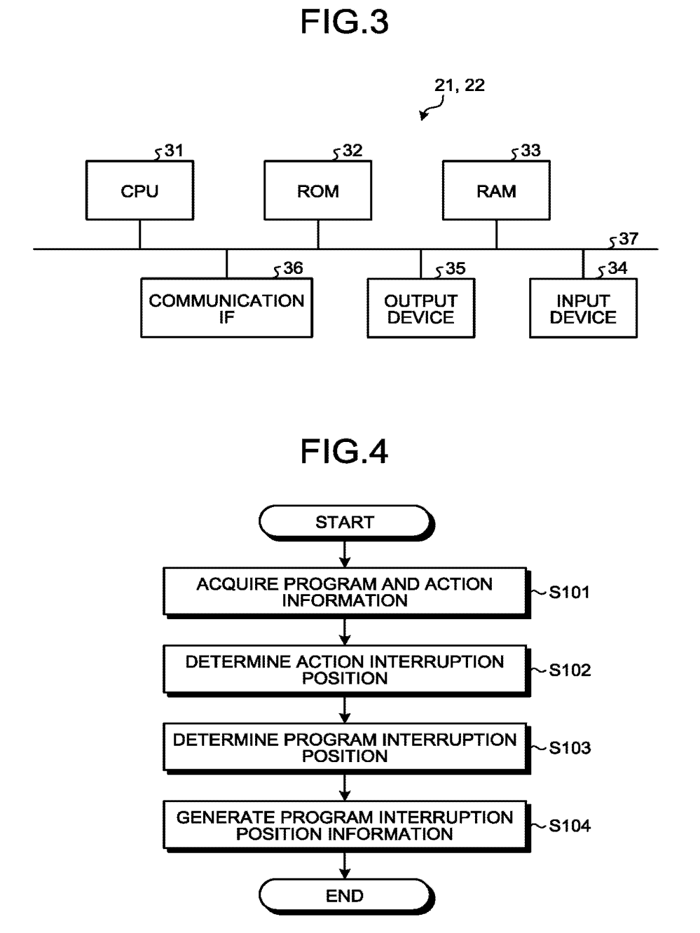

FIG. 3 is a drawing illustrating an inner configuration of each of the information processing terminal 21 and the server 22. Each of the information processing terminal 21 and the server 22 includes a central processing unit (CPU) 31, a read only memory (ROM) 32, a random access memory (RAM) 33, an input device 34, an output device 35, a communication interface (IF) 36, and a bus 37. The CPU 31 performs certain calculation processing using the RAM 33 as a working area in accordance with a control program stored in the ROM 32 and others. The input device 34 is used for inputting information from outside, and examples of the input device 34 include a keyboard, a mouse, and a touch panel. The output device 35 is a device for outputting internally generated information to the outside, and examples of the output device 35 include a display and a printer. The communication IF 31 allows the system to transmit and receive information to and from an external device through a network.

The acquiring unit 11 acquires a program and action information, the program being subject to inspection, the action information indicating the order of execution of a plurality of instruction codes included in the program. The program includes a non-interruption instruction code and an interruption instruction code. The acquiring unit 11 is configured using, for example, the CPU 31, a control program, a logic integrated circuit (IC), and the RAM 33. The term “acquiring” herein means receiving data from outside and generating data inside. The program and the action information may be generated by a system (a device) other than the program information generating system 1 or may be generated inside the program information generating system 1. Methods of generating the program and the action information are not limited, and the program and the action information may be generated using a known or a novel technique as appropriate.

The action interruption position determining unit 12 determines an action interruption position indicating a position where interruption has occurred in the action information based on the interruption instruction code and the action information. The action interruption position determining unit 12 is configured using, for example, the CPU 31, a control program, a logic IC, and the RAM 33.

The program interruption position determining unit 13 determines a program interruption position indicating a position where interruption has occurred in the program based on the non-interruption instruction code and the action interruption position. The program interruption position determining unit 13 is configured using, for example, the CPU 31, a control program, a logic IC, and the RAM 33.

The generating unit 14 generates program interruption position information that specifies a program interruption position. The generating unit 14 is configured using, for example, the CPU 31, a control program, a logic IC, and the RAM 33.

FIG. 4 is a flowchart illustrating a processing flow performed by the program information generating system 1. The acquiring unit 11 acquires a program and action information (S101). The action interruption position determining unit 12 determines an action interruption position in the action information based on the interruption instruction code included in the program and the action information (S102). The program interruption position determining unit 13 thereafter determines a program interruption position in the program based on a non-interruption instruction code included in the program and the action interruption position (S103). The generating unit 14 generates program interruption position information that specifies the program interruption position (S104).

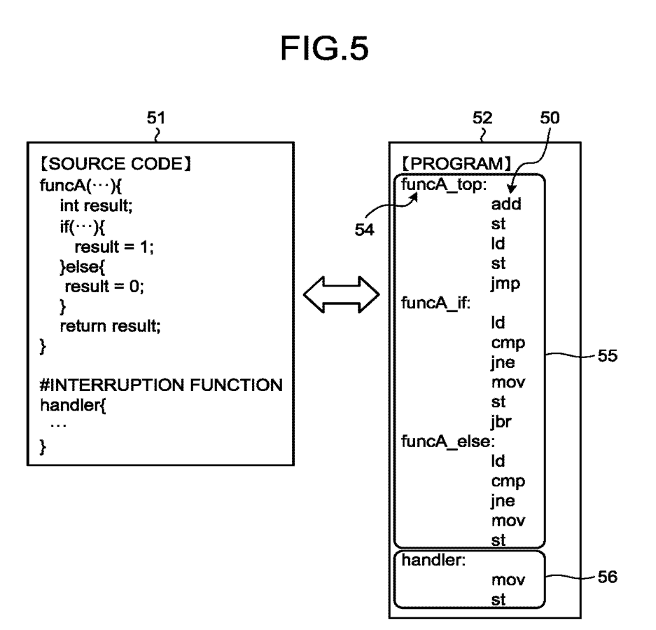

FIG. 5 is a drawing illustrating a source code 51 and a program 52. The source code 51 and the program 52 correspond to each other. The program 52 is information in which instructions for executing specific processing are written The program 52 in this example includes a plurality of instruction codes (add, st, ld, jmp, cmp, jne, mov, jbr, and others) 50 each representing the content of the instructions and labels (funcA_top, funcA_if, funcA_else, handler, and others) 54, each of which specifies a scope including one or a series of instruction codes 50. The program 52 may further include, for example, a program counter allocated to each instruction code 50.

A non-interruption instruction code 55 and an interruption instruction code 56 are included in the instruction codes 50. The interruption instruction code 56 is an instruction code for having the interruption processing executed. The non-interruption instruction code 55 is an instruction code other than the interruption instruction code 56.

The program 52 in this example corresponds to a function funcA of the source code 51. The non-interruption instruction code 55 in this example is configured with a plurality of instruction codes 50 to which three labels 54 of funcA_top, funcA_if, and funcA_else are assigned. The function funcA includes branch processing. Five instruction codes (add, st, ld, st, and jmp) 50 not including branch processing are assigned with the label 54 of funcA_top. Six instruction codes (ld, cmp, jne, mov, ct, and jbr) 50 representing if statements and the inner processing of the function funcA are assigned with the label 54 of funcA_else. Five instruction codes (ld, cmp, jne, mov, and st) 50 representing else statements and the inner processing of the function funcA are assigned with the label 54 of funcA_else.

The function handler the source code 51 is a function for executing interruption processing. The interruption instruction code 56 in this example is configured with a plurality of instruction codes (mov and st) 50 assigned with the label 54 of handler.

It is preferable that the function for executing the interruption processing be preliminarily designated. The function for executing the interruption processing may be manually designated by a user or may be automatically detected and designated by processing of the control program.

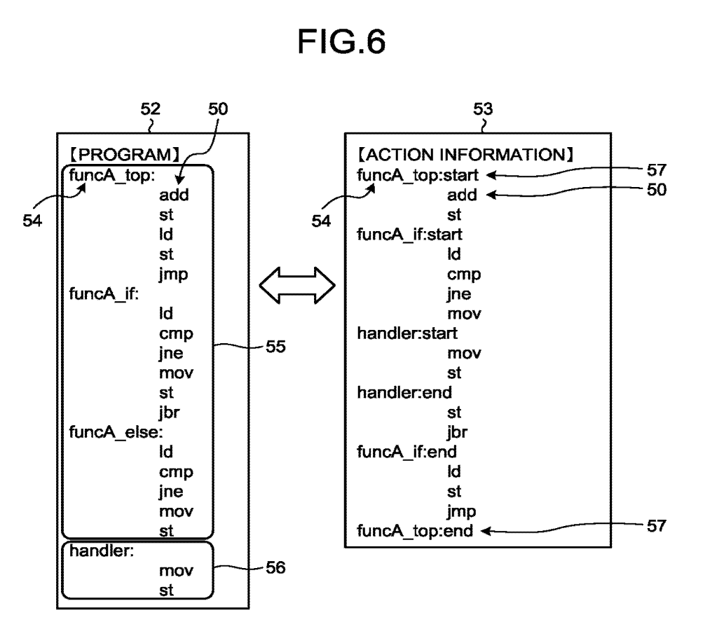

FIG. 6 is a drawing illustrating the program 52 and action information 53. The action information 53 is information indicating the order of execution of the interruption instruction code 55 and the interruption instruction code 56 included in the program 52. In the action information 53 of this example, a plurality of instruction codes 50 are written in the order of execution. The action information 53 of this example is an example in which interruption processing is performed by the function handler during the branch processing in the function funcA. This example includes attached labels (start and end) 57 representing a start and an end of the action of each scope funcA_top, funcA_if, and handler; however, the attached labels 57 are not always necessary.

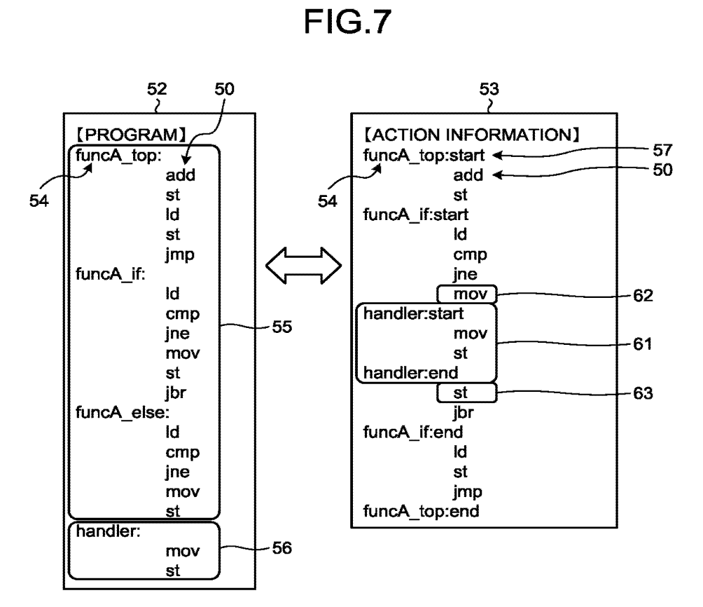

FIG. 7 is a drawing illustrating a method of determining an action interruption position 61. The action interruption position determining unit 12 determines the action interruption position 61 representing a position where interruption has occurred in the action information 53 based on the interruption instruction code 56 included in the program 52 and the action information 53.

The action interruption position determining unit 12 detects a part (a coincident part) coinciding with the interruption instruction code (mov and st) 56 from a plurality of instruction codes 50 included in the action information 53 and determines the coincident part to be the action interruption position 61. The method of detecting the coincident part is not limited, and any method using a known or a novel technique as appropriate is applicable. The coincident part can be detected in the action information 53 using the instruction codes (mov and the function handler and the label (handler) 54 as search keywords. The instruction codes (such as ld, cmp, jne, mov, st, and jbr) 50 in the non-interruption instruction code 55 and the labels (such as funcA_if) 54 may also be used as search keywords. Use of the instruction codes 50 of the non-interruption instruction code 55 and the labels 54 as search keywords allows the user to check the order of the instruction codes 50 arranged ahead of and behind the coincident part, thereby more accurately detecting the coincident part.

In the action information 53 in this example, the interruption instruction codes (mov and st) 50 of handler are interposed between the attached label 57, start, representing an action start of funcA_if and the attached label 57, end, representing an action end of funcA_if. This structure of the action information 53 allows the user to understand that interruption has occurred in the if statement of the function funcA.

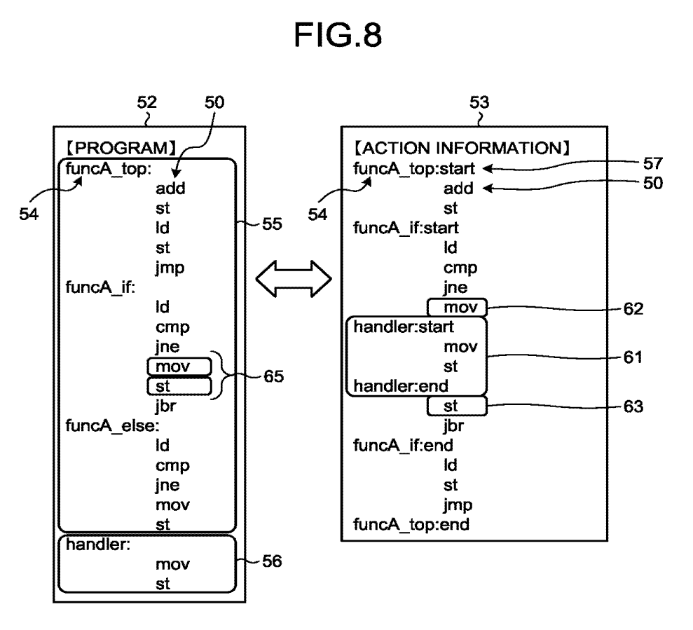

FIG. 8 is a drawing illustrating a method of determining the program interruption position 65. The program interruption position determining unit 13 determines the program interruption position 65 representing a position where interruption has occurred in the program 52 based on the non-interruption instruction code 55 included in the program 52 and the action interruption position 61 determined in the above-described manner.

The program interruption position determining unit 13 detects an immediately preceding instruction code 62 positioned immediately ahead of the action interruption position 61 and an immediately following instruction code 63 positioned immediately behind the action interruption position 61. The program interruption position determining unit 13 thereafter detects a part (a successive part) where the immediately preceding instruction code 62 and the immediately following instruction code 63 are successively positioned in the non-interruption instruction code 55 and determines the successive part to be the program interruption position 65. The method of detecting the successive part is not limited, and any method using a known or a novel technique as appropriate may be applicable. The successive part (the program interruption position 65) can be detected in the non-interruption instruction code 55 using, for example, the immediately preceding instruction code (mov) 62, the immediately following instruction code 63, and the label (funcA_if) 54 representing a scope including these codes as search keywords. Furthermore, the instruction codes (such as ld, cmp, jne, mov, st, and jbr) 50 positioned ahead of and behind the immediately preceding instruction code 62 and the immediately following instruction code 63 and the label (such as funcA_if) 54 in the action information 53 may be used as search keywords. Use of the instruction codes 50 positioned ahead of and behind the immediately preceding instruction code 62 and the immediately following instruction code 63 and the label 54 as search keywords allows the user to check the order of the instruction codes 50 arranged ahead of and behind the successive part, which enables more accurate detection of the successive part.

The successive part (the program interruption position 65) in this example is positioned at the two instruction codes 50: “mov” and “st” in funcA_if of the non-interruption instruction code 55. This indicates that interruption has occurred after execution of the instruction code 50: “mov” and before execution of the instruction code 50: “st” in the if statement in the function funcA. In this manner, with the program interruption position 65, an interruption occurrence position can be specified at the level of instruction codes 50 of the program 52.

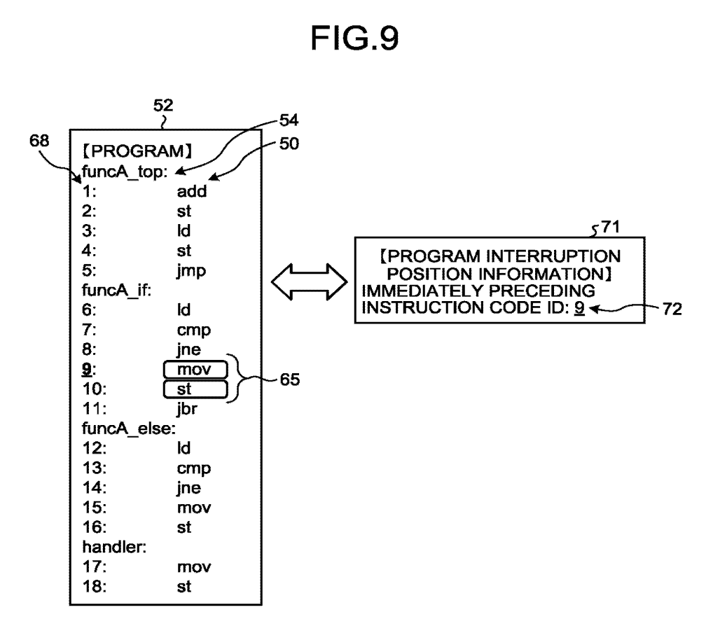

FIG. 9 is a drawing illustrating program interruption position information 71 of the first example. The generating unit 14 generates the program interruption position information 71 uniquely indicating the program interruption position 65. In this example, the program 52 includes first identification numbers 68. The first identification number 68 is a number uniquely allocated to each instruction code 50 included in the program 52. The program interruption position information 71 of this example includes an immediately preceding instruction code ID 72 (instruction code specifying information) indicating the first identification number 68 corresponding to the immediately preceding instruction code 62. The immediately preceding instruction code ID 72: “9” of this example corresponds to the instruction code 50: “mov” in funcA_if of the program 52 In other words, the program interruption position information 71 of this example indicates that interruption has occurred immediately after execution of the instruction code 50: “mov” in funcA_if.

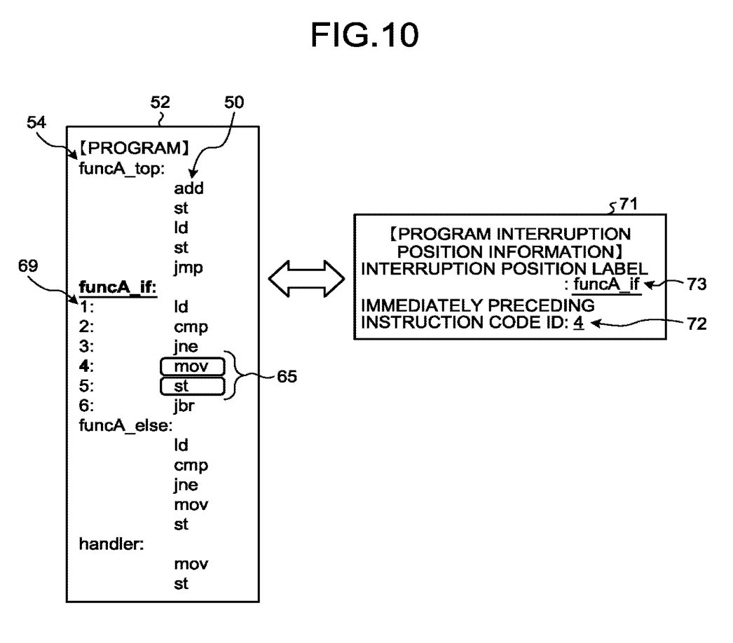

FIG. 10 is a drawing that illustrates exemplary program interruption position information 71 of a second example. In this example, the program 52 includes second identification numbers 69. The second identification number 69 is a number uniquely allocated exclusively to each instruction code 50 in the scope including the program interruption position 65. The program interruption position information 71 of this example includes the immediately preceding instruction code ID 72 and an interruption position label 73 (scope specifying information). The interruption position label 73 indicates the label 54 representing a scope including the program interruption position 65. The immediately preceding instruction code ID 72: “4” of this example corresponds to the instruction code 50: “mov” in funcA_if of the program 52. In other words, as is the first example of FIG. 9, the program interruption position information 71 of this example indicates that interruption has occurred immediately after execution of tie instruction code 50: “mov” in funcA_if.

The program interruption position information 71 is not limited to the above-described examples. For example, the program interruption position information 71 may include an ID corresponding to the immediately following instruction code 63 in addition to or instead of the immediately preceding instruction code ID 72.

The program interruption position information 71 generated in the above-described manner can be used for various purposes. For example, the program interruption position information 71 may be directly output to a display or the like of a computer may be provided for another system such as a system visualizing the status of execution of the program 52 and verifying the program 52 (the source code 51) using, for example, a graphical user interface (GUI).

The hardware configurations illustrated in FIG. 2 and FIG. 3 are merely examples, and the program information generating system 1 can be implemented in various hardware configurations. For example, the program information generating system 1 may be configured by a single general-purpose computer, a dedicated device having an embedded processor, and others.

FIG. 1 illustrates a configuration in which the acquiring unit 11, the action interruption position determining unit 12, the program interruption position determining unit 13, and the generating unit 14 as most basic functional blocks of the program information generating system 1 are connected with one another in the order of processing; however, the embodiments are not limited thereto. For example, the program information generating system 1 may be configured with functional blocks performing processing in a manner cooperating with one another in parallel, configured in a different order of the functional blocks, configured with a single functional block divided into a plurality of functional blocks, or configured in a combination of these three configurations.

A control program implementing the functions of the program information generating system 1 can be recorded in a computer-readable memory medium such as a CD-ROM, a flexible disk (FD), a CD-R, a DVD, and the like and provided in an installable or executable file. The control program may be provided by being downloaded from a certain memory device connected to a network to a certain computer or may be provided to a certain information processing device by being preliminarily embedded in a ROM or the like. The control program may be configured with a plurality of modules implementing the functions of the above-described acquiring unit 11, action interruption position determining unit 12, program interruption position determining unit 13, and generating unit 14.

According to the above-described first embodiment, an interruption occurrence position can be specified at the level of instruction codes 50 of the program 52.

Other embodiments will now be described with reference to the drawings. Like numerals indicate like or identical items in the first embodiment, and description thereof may be omitted.

### Second Embodiment

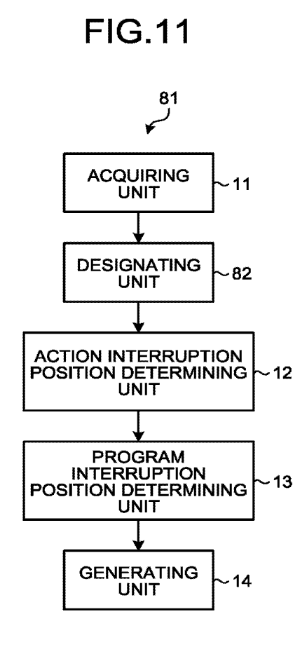

FIG. 11 is a drawing illustrating a functional configuration of a program information generating system 81 in a second embodiment. The program information generating system 81 includes a designating unit 62 in addition to the configuration of the program information generating system 1 of the first embodiment.

The designating unit 82 designates one or more scopes of a plurality of scopes included in the program 52. The designating unit 62 is configured using, for example, the CPU 31, a control program, a logic IC, and the RAM 33. The action interruption position determining unit 12 determines the action interruption position 61 in the designated scope. The program interruption position determining unit 13 determines the program interruption position 65 in the designated scope. In other words, in the second embodiment, a range for determining an interruption occurrence position in the program 52 can be designated.

A scope designated by the designating unit 82 is a section including one or successive instruction codes 50. The designated scope is typically a section by the function unit assigned with the label 54; however, the embodiments are not limited thereto. The scope may be manually designated by a user or may be automatically designated by the processing of a control program in accordance with a certain condition.

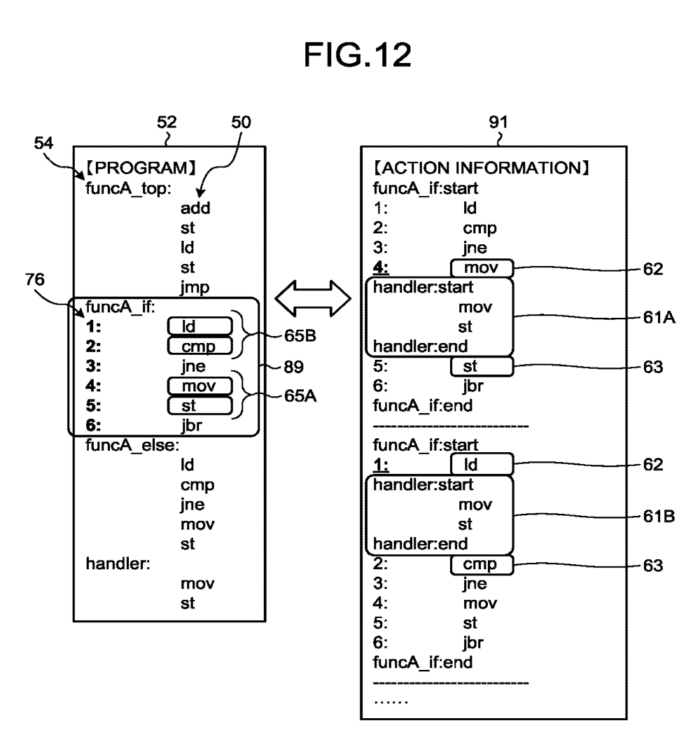

FIG. 12 is a drawing illustrating the program 52 and action information 91 of the second embodiment. A designated section 89 illustrated in FIG. 12 is a scope designated by the designating unit 62. In this example, the designating unit 82 selects a scope assigned with the label 54 of funcA_if from the program 52. The designated section 89 includes six instruction codes (ld, cmp, jne, mov, st, and jbr) 50 and an identification number 76 uniquely allocated to each instruction code 50.

The action interruption position determining unit 12 in this embodiment determines the action interruption position 61 exclusively in the designated section 89. The action information 91 indicates only the order of execution in the designated section 89. The action information 91 in this example is information generated by repeating simulations on the designated section 89. In this embodiment, two action interruption positions 61A and 61B in respective simulations are described.

The program interruption position determining unit 13 in this embodiment determines program interruption positions 65A and 65B in the designated section 89 based on the action interruption positions 61A and 61B and the program as is described in the first embodiment. The program interruption position 65A corresponds to the action interruption position 61A, whereas the program interruption position 65B corresponds to the action interruption position 61B. As is described in the first embodiment, the generating unit 14 generates the program interruption position information 71 based on the program interruption positions 65A and 65B determined in this manner.

According to the second embodiment, an interruption occurrence position can be determined exclusively in a scope requested by the user. This method can prevent generation of unnecessary information and facilitate a check of verification results in each scope.

### Third Embodiment

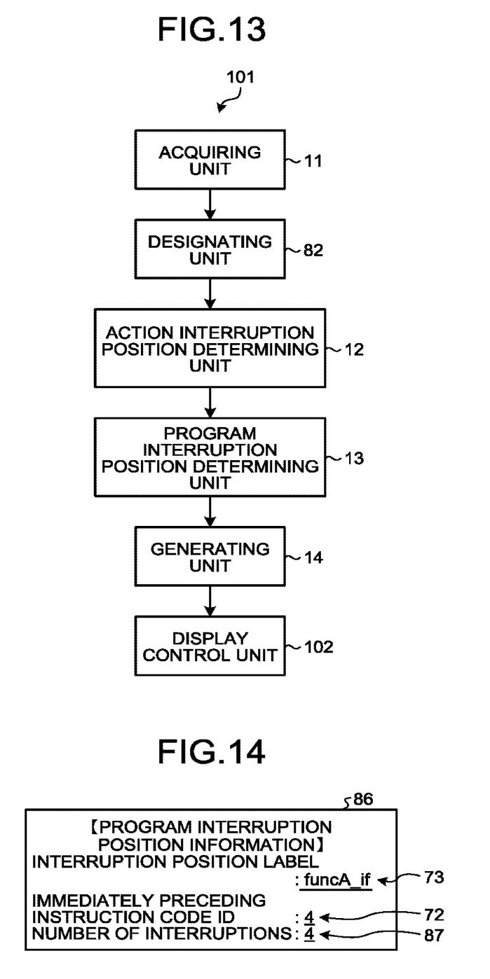

FIG. 13 is a drawing illustrating a functional configuration of a program information generating system 101 in a third embodiment. The program information generating system 101 includes a display control unit 102 in addition to the configuration of the program information generating system el of the second embodiment.

The display control unit 102 controls a display unit to display a display image depicting the status of execution of the interruption instruction code 56 based on the program interruption position information generated by the generating unit 14. The display unit is a device outputting an image, examples of which include a display and a printer. The display control unit 102 is configured using, for example, the CPU 31, a control program, a logic IC, and the RAM 33.

FIG. 14 is a drawing that illustrates exemplary program interruption position information 86 generated by the generating unit 14 of the third embodiment. The program interruption position information 86 in this example includes the immediately preceding instruction code ID 72, the interruption position label 73, and the number of interruptions (the number of times of interruptions) 87 (interruption frequency information). The immediately preceding instruction code ID 72 and the interruption position label 73 of this example are the same as the immediately preceding instruction code ID 72 and the interruption position label 73 of the second example in the first embodiment illustrated in FIG. 10. The number of interruptions 87 indicates the number of executions of the interruption instruction code 56 at an interruption occurrence position (after execution of the instruction code 50: “mov” indicated by the immediately preceding instruction code ID 72: “4”) 65 in the scope (the interruption position label 73: “funcA_if”) designated by the designating unit 82. This program interruption position information 86 is generated on every simulation. In other words, the program interruption position information 86 is generated based on the interruption occurrence position (the immediately preceding instruction code ID 72) changed on each simulation and the number of interruption occurrences (the number of interruptions 87) accumulated at the position.

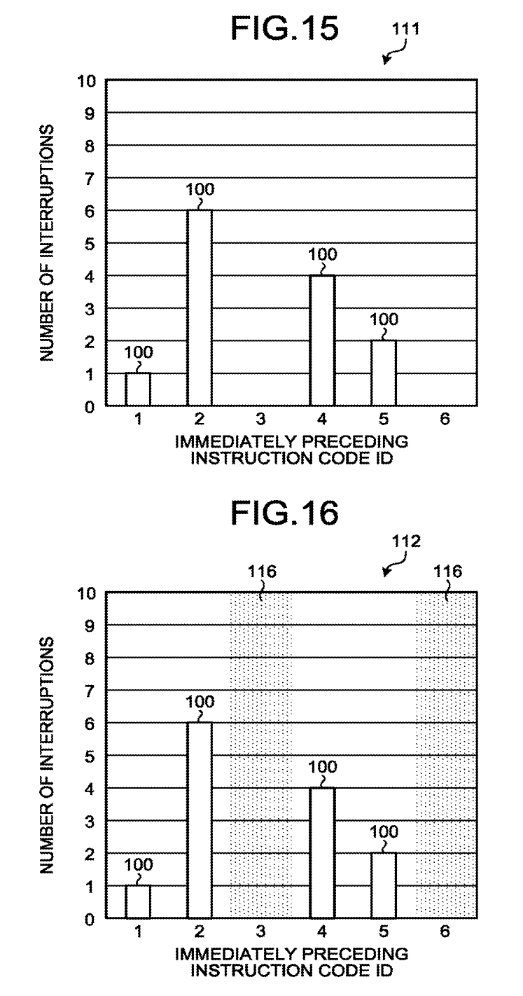

FIG. 15 is a drawing illustrating a display image 111 of a first example in the third embodiment. The display image 111 in this example depicts count objects 100, each of which represents the number of interruptions 87 for the immediately preceding instruction code ID 72. In this example, interruption processing has occurred: once at the program interruption position(after execution of ld in funcA_if in FIG. 10) indicated by the immediately preceding instruction code ID 72: “1”, six times at the program interruption position 65 (after execution of cmp in funcA_if in FIG. 10) indicated by the immediately preceding instruction code ID 72: “2”, four times at the program interruption position 65 (after execution of mov in funcA_if in FIG. 10) indicated by the immediately preceding instruction code ID 72: “4”, and twice at the program interruption position 65 (after execution of st in funcA_if in FIG. 10) indicated by the immediately preceding instruction code ID 72: “5”, whereas no interruption processing has occurred at the program interruption pro 65 (after execution of jne or jbr in funcA_if in FIG. 10) indicated by the immediately preceding instruction code ID 72: “3” or “6”.

FIG. 16 is a drawing illustrating a display image 112 of a second example in the third embodiment. The display image 112 in this example depicts emphasis objects 116 at the fields of immediately preceding instruction code IDs 72: “3” and “6” in a display form different from the form of other fields. Examples of the display form include a color brightness, and blinking. The emphasis object 116 is depicted in a part in which the number of interruptions 87 satisfies a certain condition. The certain condition in this example is the number of interruptions 87 being “0”. The certain condition is, however, not limited thereto. The number of interruptions 87 may be equal to or more than a certain value.

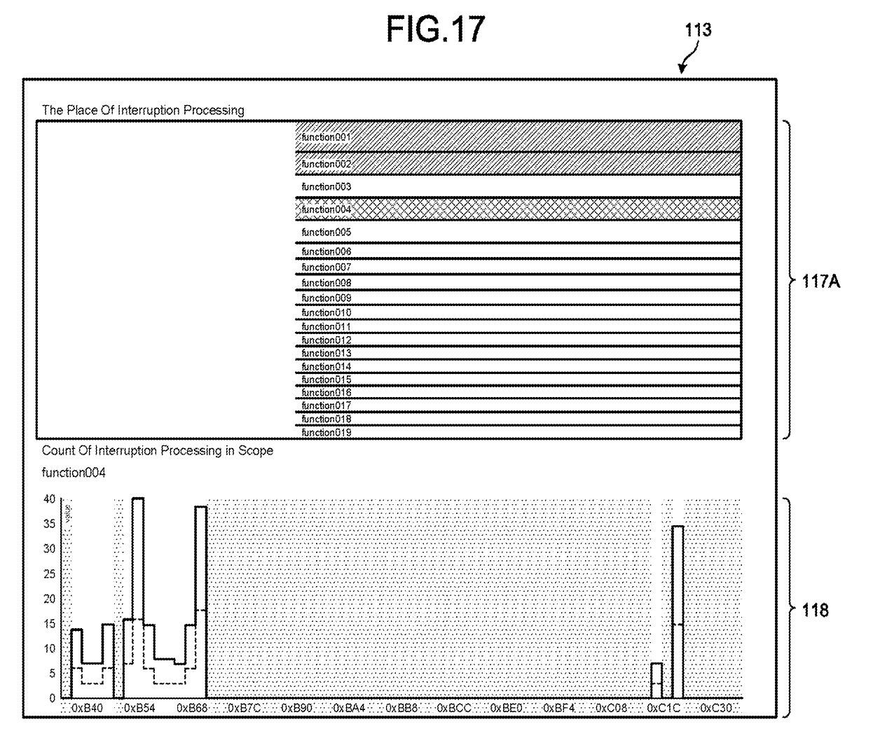

FIG. 17 is a drawing illustrating a display image 113 of a third example in the third embodiment. The display image 113 in this example includes a scope designation field 117A and a result display field 116.

The scope designation field 117A is a field for having a user select a desired scope from a plurality of scopes (functions) included in the program 52. In this example, a plurality of scopes are displayed in a list, and the can designate a desired scope using a mouse, a touch panel, or the like. For example, a column of a scope selected by the user and a column of a scope in which the interruption processing has occurred may be emphasized by using a display form different from the forms of the other columns.

The result display field 118 displays a graph depicting the status of execution of the interruption processing in a designated scope in the scope designation field 117A.

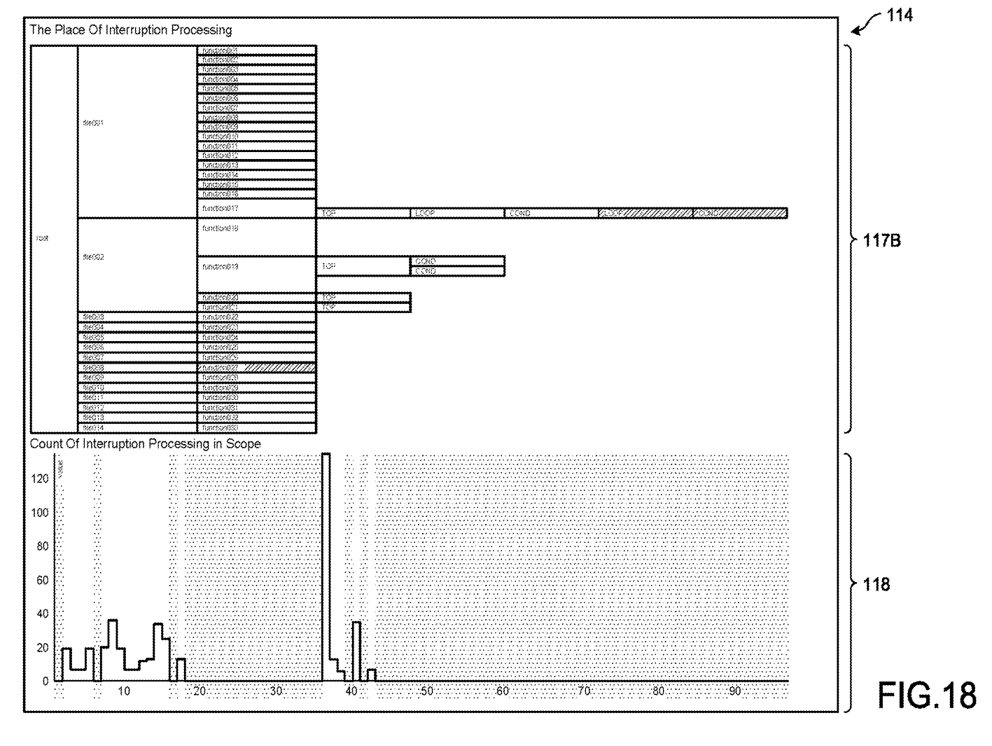

FIG. 18 is a drawing illustrating a display image 114 of a fourth example in the third embodiment. In a scope designation field 117B of this example, a plurality of scopes included in the program 52 are displayed such that inclusion relation thereof can be recognized. This example hierarchically displays, from the left side, a box of “root” representing the overall program, boxes representing files in the program, boxes representing functions written in each file, and boxes representing the conditional branch “COND” and the loop “LOOP” included in each function. This structure allows the user to designate a scope with consideration of the inclusion relation of the scope.

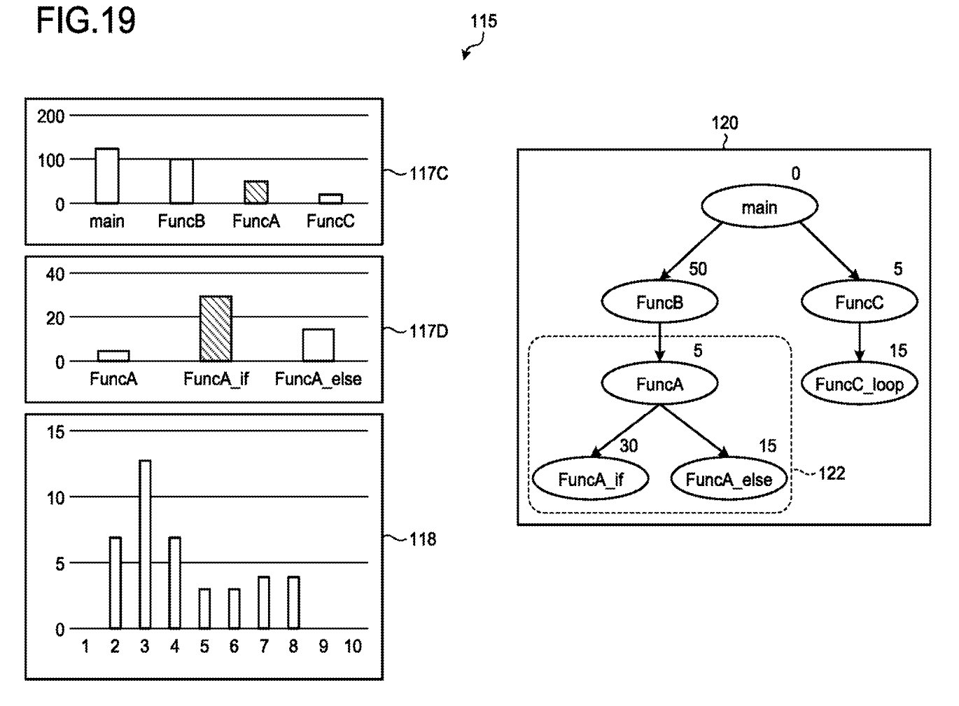

FIG. 19 is a drawing illustrating a display image 115 of a fifth example in the third embodiment. The display image 115 in this example includes a first scope designation field 117C, a second scope designation field 117D, and the result display field 118. In this example, the generating unit 14 determines items to be displayed on the abscissa of the second scope designation field 117D from information (described later) indicating the call relation between the scopes of a call tree 120.

The call tree 120 depicts scopes in the program 52 as nodes and depicts the call relation between the scopes. The number written on the top right of each node represents the number of interruptions having occurred in the node. The first scope designation field 117C is a field for designating a comparatively wide section (scope) in the program 52. The second scope designation field 117D is a field for designating a more detailed section than the first scope designation field 117C. The result display field 118 displays a graph depicting the status of execution of the interruption processing in a section designated in the second scope designation field 117D. This structure allows the user to designate a scope in two steps from designation of a wider section to designation of a more detailed section using information indicating the call relation between the scopes depicted in the call tree 120. The display control unit 102 may have the display unit display the call tree 120.

Designation of a section in the first step will now be described. Items representing comparatively wide sections in a file, a program of a function, or the like are given on the abscissa of the first scope designation field 117C. The total number of times of interruption processing having occurred during execution of the section of each item is given on the ordinate. In order obtain the total number of times of interruption processing having occurred during execution of a section, it is necessary to obtain the number of times of interruption processing having occurred in all the sections called during execution of the section. The call tree depicts the number of times of interruption processing to be obtained. For example, the number of interruptions having occurred in FuncA is the total number of interruptions having occurred in FuncA and all of its descendant nodes, FuncA_if and FuncA_else as illustrated in a branch portion 122. The total number of interruptions having occurred during execution of FuncA is therefore counted as: 5+30+15=50. The user designates a comparatively wide section from the first scope designation field 117C with reference to such information.

After completing the first step of designating a section in the above-described manner, the process proceeds to the second step of designating a more detailed section. This example describes a case in which FuncA is designated at the first step. The abscissa of the second scope designation field 117D lists all the items representing sections that run during execution of FuncA. The given items can be acquired from the descendant nodes of the FuncA node in the all tree 120. In this example, three items, FuncA, FuncA_if, and FuncA_else are displayed. The total number of times of interruption processing having occurred during execution of the section of each item is given on the ordinate. Unlike the first scope designation field 117C, the ordinate of the second scope designation field 117D does not include the number of interruptions having occurred in another section. Upon designation of a desired section, for example, FuncA_if, from the second scope designation field 117D, a graph depicting the status of execution of interruption processing in FuncA_if is displayed on the result display field 116.

The program interruption position information 86 and the display images 111 to 115 are merely examples, and the embodiments are not limited thereto. The program interruption position information 86 illustrated in FIG. 14 includes the number of interruptions 87; however, even with the program interruption position information 71 not including the number of interruptions 87 as illustrated in FIG. 10, the above-described display images 111 and 112 can be generated by, for example, counting the number of pieces of the program interruption position information 71. Furthermore, various display images can be generated by changing the content of the above-described program interruption position information 71 and 86 as appropriate.

According to the above-described third embodiment, display images 111 to 115 visually depicting the status of execution of the interruption instruction code 56 in a scope requested by the user can be generated by using the results of designation given by the designating unit 82 and the program interruption position information 86 generated by the generating unit 14.

### Fourth Embodiment

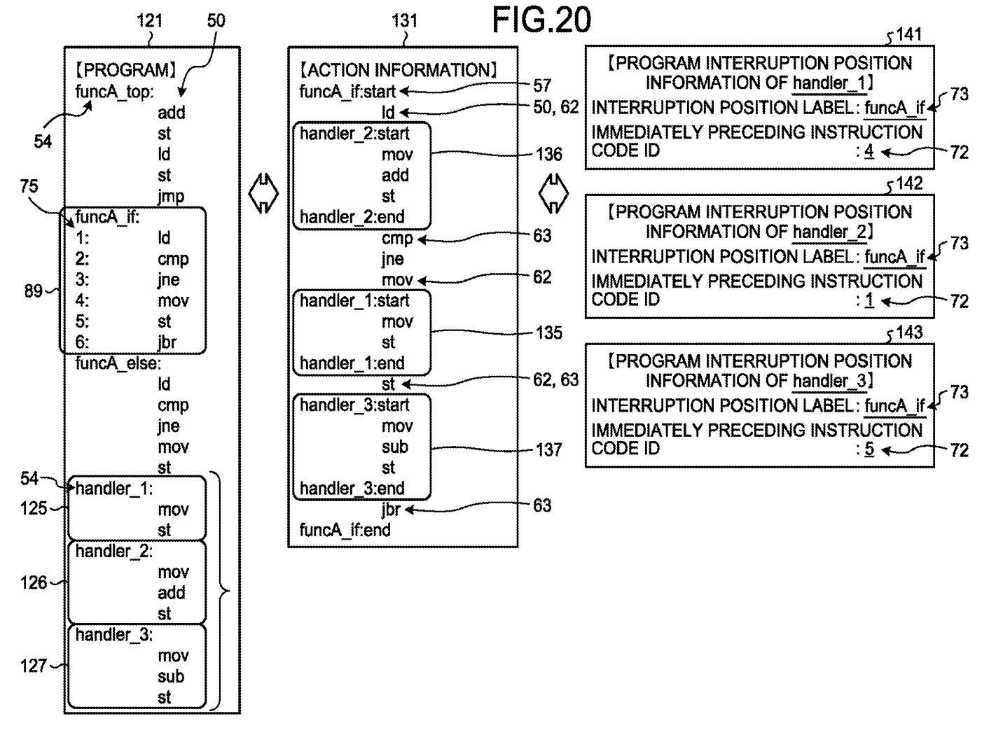

FIG. 20 is a drawing illustrating a program 121, action information 131, and program interruption position information 141 to 143 in a fourth embodiment. The program 52 in the first to the third embodiments include one interruption instruction code 56, whereas a program 121 in this embodiment includes a plurality of (three) interruption instruction codes 125 to 127. One piece of action information 131 accordingly includes three action interruption positions 135 to 137, which accordingly generates three pieces of program interruption position information 141 to 143.

The first interruption instruction code 125 is configured with two instruction codes 50: “mov” and “st” to which the label 54: “handler 1” is assigned. The second interruption instruction code 126 is configured with three instruction codes 50: “mov”, “add”, and “st” to which the label 51: “handler 2” is assigned. The third interruption instruction code 127 is configured with three instruction codes : “mov”, “sub”, and “st” to which the label 54: “handler_3” is assigned.

The first action interruption position 135 corresponds to the first interruption instruction code 125. The second action interruption position 136 corresponds to the second interruption instruction code 126. The third action interruption position 137 corresponds to the third interruption instruction code 127. The action interruption positions 135 to 137 can be determined by performing the same processing as that of the first embodiment on the respective interruption instruction codes 125 to 127.

The first program interruption position information 141 corresponds to the first action interruption position 135. The second program interruption position information 142 corresponds to the second action interruption position 136. The third program interruption position information 143 corresponds to the third action interruption position 137. The program interruption positions 141 to 143 can be generated by performing the same processing as that of the first embodiment on the respective action interruption positions 135 to 137.

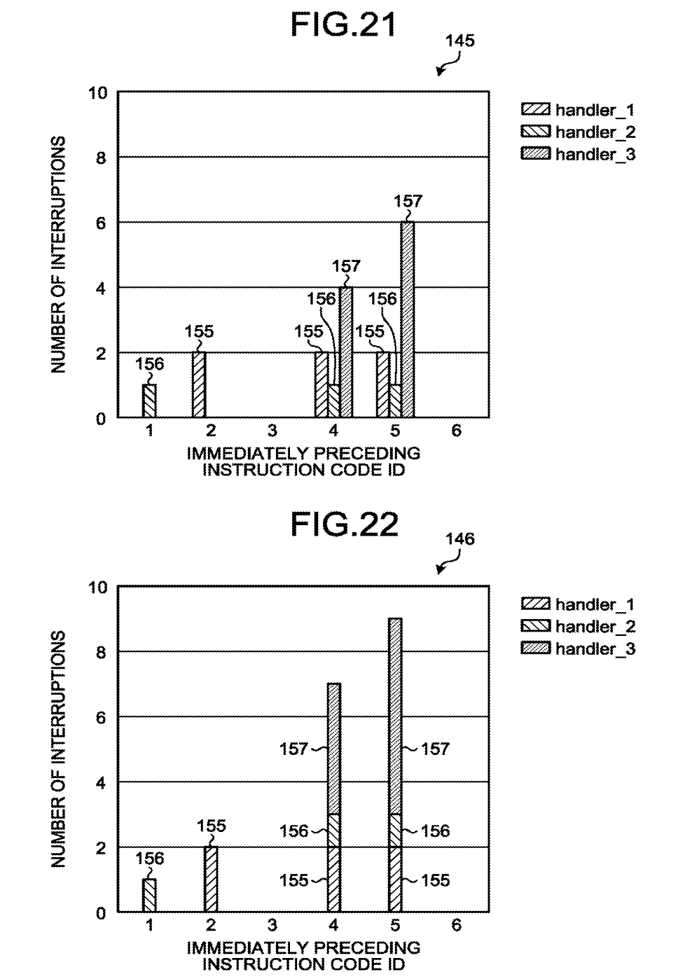

FIG. 21 is a drawing illustrating a display image 145 of a first example in the fourth embodiment. The display image 145 in this example transversely depicts three types of count objects 155 to 157 (a first count object 155 to a third count object 157) for each immediately preceding instruction code ID 72 (interruption occurrence position). The first count object 155 corresponds to the first interruption instruction code 125. The second count object 156 corresponds to the second interruption instruction code 126. The third count object 157 corresponds to the third interruption instruction code 127. For example, the display image depicts that, at an interruption occurrence position indicated by the immediately preceding instruction code ID 2: “4”, the first interruption instruction code 125 has been executed twice, the second interruption instruction code 126 has been executed once, and the third interruption instruction code 127 has been executed four times. This display manner allows the user to easily understand the number of interruptions for an interruption occurrence position on each of the interruption instruction codes 125 to 127.

FIG. 22 is a drawing illustrating a display image 146 of a second example in the fourth embodiment. The display image 152 in this example serially depicts three types of count objects 155 to 157 for each immediately preceding instruction code ID 72. This display manner allows the user to easily understand the number of interruptions for an interruption occurrence position by counting the total number of interruptions of the interruption instruction codes 125 to 127.

The display images 145 and 146 are merely examples, and the embodiments are not limited thereto. For example, the emphasis object 116 illustrated in FIG. 16 may be added to the display images.

According to the above-described fourth embodiment, in the case in which a plurality of interruption instruction codes 125 to 127 exist, the interruption occurrence position for each of the interruption instruction codes 125 to 127 is obtained. Furthermore, easier comparison in the number of interruptions between the interruption instruction codes 125 to 127 facilitates comparison in behavior between the interruption instruction codes 125 to 127 in an action information piece 131.

### Fifth Embodiment

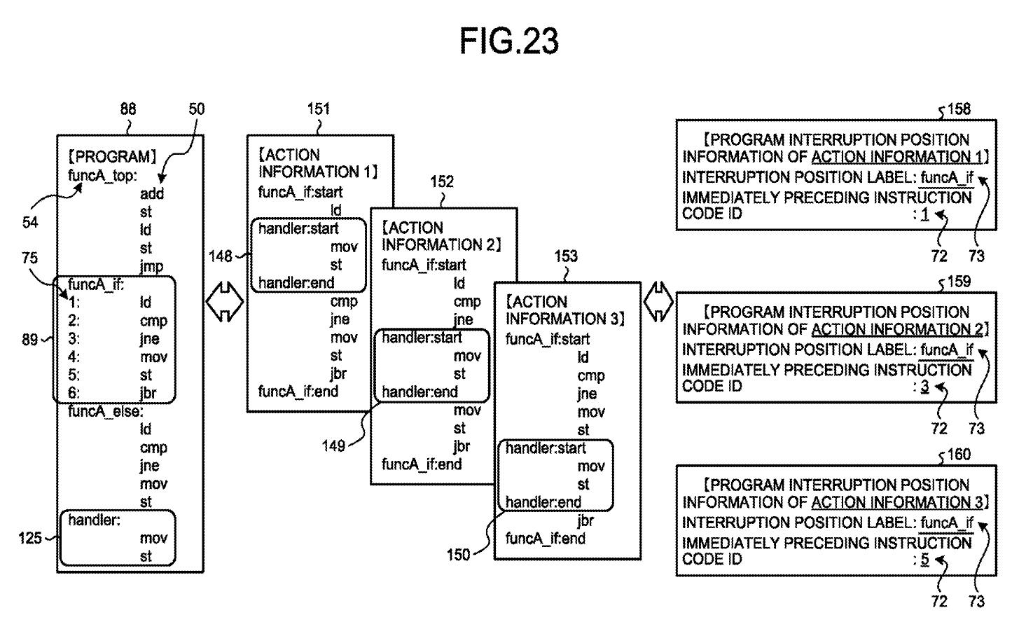

FIG. 23 is a drawing illustrating a program 88, action information 151 to 153, and program interruption position information 158 to 160 in a fifth embodiment. In this embodiment, the program 87 includes one interruption instruction code 125, and a plurality of pieces of (three) action information 151 to 153 are acquired. Three pieces of program interruption position information 158 to 160 are accordingly generated in a manner corresponding to the respective pieces of action information 151 to 153.

Three pieces of action information 151 to 153 are acquired by, for example, executing the program 88 three times under respective different conditions. A first action interruption position 148 in the first action information 151, a second action interruption position 149 in the second action information 152, and a third action interruption position 150 in the third action information 153 are different from one another.

The first program interruption position information 158 corresponds to the first action information 151 (the first action interruption position 148). The second program interruption position information 159 corresponds to the second action information 152 (the first action interruption position 149). The third program interruption position information 169 corresponds to the third action information 153 (the third action interruption position 150).

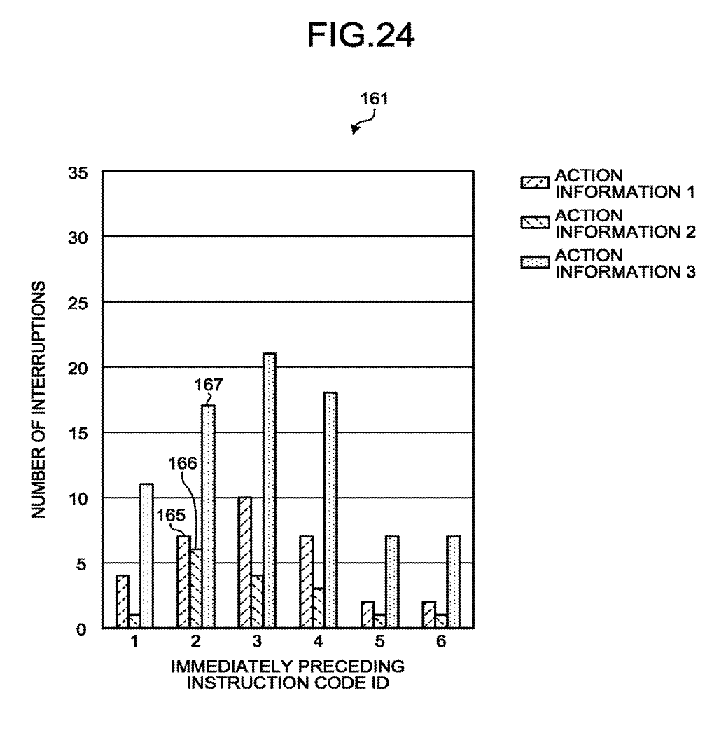

FIG. 24 is a drawing illustrating a display image 161 of a first example in the fifth embodiment. The display image 161 in this example transversely depicts three types of count objects 165 to 167 (a fourth count object 165 to a sixth count object 167) for each immediately preceding instruction code ID 72. The fourth count object 165 corresponds to the first action information 151. The fifth count object 166 corresponds to the second information 152. The sixth count object 167 corresponds to the third action information 153. This display manner allows the user to easily understand the number of interruptions for an interruption occurrence position on each of the pieces of action information 151 to 153.

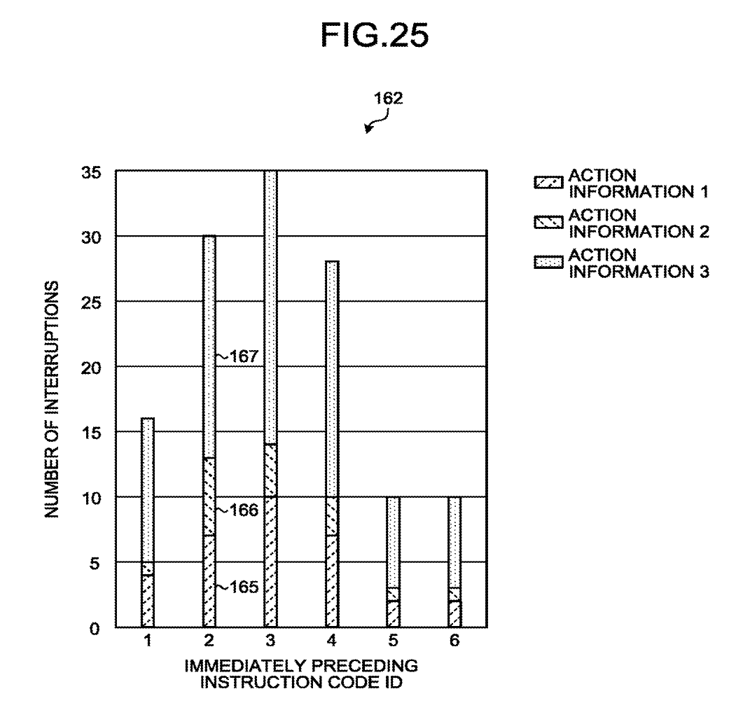

FIG. 25 is a drawing illustrating a display image 162 of a second example in the fifth embodiment. The display image 162 in this example serially depicts three types of count objects 165 to 167 for each immediately preceding instruction code ID 72. This display manner allows the user to easily understand the number of interruptions for an interruption occurrence position by adding the number of interruptions in each of the pieces of action information 151 to 153 together.

The display images 161 and 162 are merely examples, and the embodiments are not limited thereto. For example, the emphasis object 116 illustrated in FIG. 16 may be added to the display images.

According to the above-described fifth embodiment, in the case in which a plurality of pieces of action information 151 to 153 exist, the interruption position for each of the pieces of action information 151 to 153 is obtained. Furthermore, easier comparison in the number of interruptions between the pieces of action information 151 to 153 facilitates comparison in behavior between the pieces of action information 151 to 153 for an interruption instruction code 125.

### Sixth Embodiment

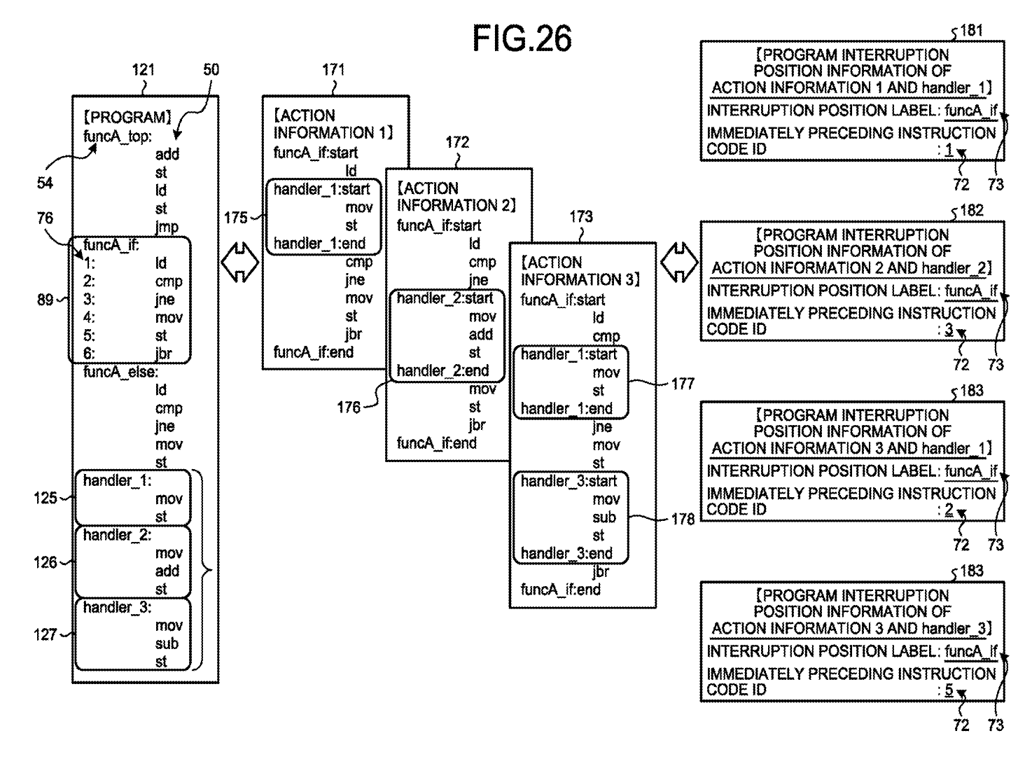

FIG. 26 is a drawing illustrating a program 121, action information 171 to 173, and program interruption position information 181 to 184 in a sixth embodiment. In this embodiment, the program 121 includes a plurality of (three) interruption instruction codes 125 to 127, and a plurality of pieces of (three) action information 171 to 173 are acquired. A plurality of pieces of (four pieces in this example) program interruption position information 181 to 184 are accordingly generated in a manner corresponding to the combinations of interruption instruction codes 125 to 127 and action information 171 to 173.

In this embodiment, the first action information 171 includes the first action interruption position 175 corresponding to the first interruption instruction code 125 The second action information 172 includes the second action interruption position 176 corresponding to the second interruption instruction code 126. The third action information 173 includes the third action interruption position 177 corresponding to the first interruption instruction code 125 and the fourth action interruption position 178 corresponding to the third interruption instruction code 127.

The first program interruption position information 181 corresponds to the first action interruption position 175. The second program interruption position information 162 corresponds to the second action interruption position 176. The third program interruption position information 183 corresponds to the third action interruption position 177. The fourth program interruption position information 184 corresponds to the fourth action interruption position 176.

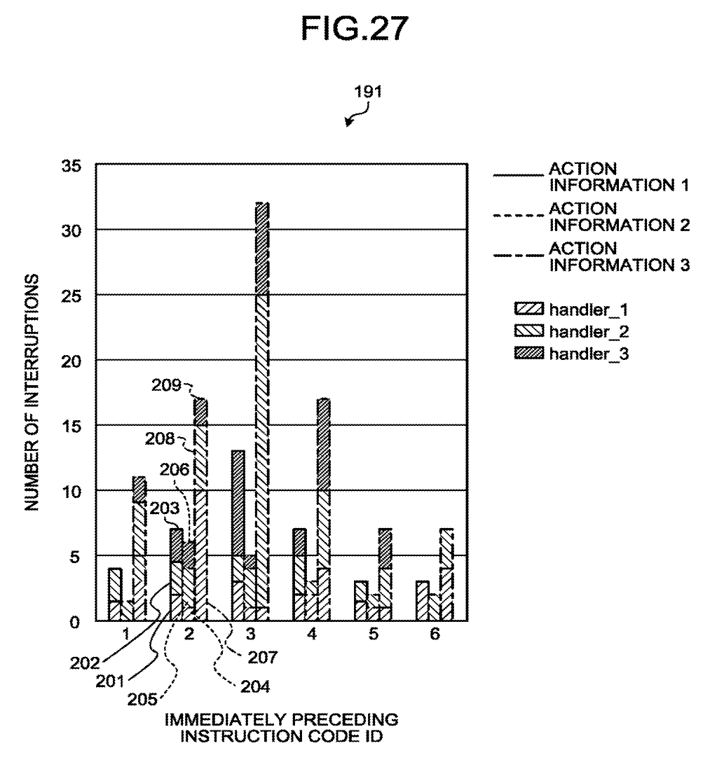

FIG. 27 is a drawing illustrating a display image 191 in the sixth embodiment. The display image 191 in this example depicts nine types of count objects 201 to 209 (a seventh count object 201 to a fifteenth count object 209) for each immediately preceding instruction code ID 72 (interruption occurrence position). The seventh count object 201 corresponds to the combination of the first action information 171 and the first interruption instruction code 125. The eighth count object 202 corresponds to the combination of the first action information 171 and the second interruption instruction code 126. The ninth count object 203 corresponds to the combination of the first action information 171 and the third interruption instruction code 127. The tenth count object 204 corresponds to the combination of the second action information 172 and the first interruption instruction code 125. The eleventh count object 205 corresponds to the combination of the second action information 172 and the second interruption instruction code 126. The twelfth count object 206 corresponds to the combination of the second action information 172 and the third interruption instruction code 127. The thirteenth count object 207 corresponds to the combination of the third action information 173 and the first interruption instruction code 125. The fourteenth count object 208 corresponds to the combination of the third action information 173 and the second interruption instruction code 126. The fifteenth count object 109 corresponds to the combination of the third action information 173 and the third interruption instruction code 127. This display manner allows the user to easily understand the number of interruptions for an interruption occurrence position on each of the combinations of the interruption instruction codes 125 to 127 and the action information 171 to 173.

The display image 191 is a merely example, and the embodiments are not limited thereto. For example, the emphasis object 116 illustrated in FIG. 16 may be added to the display images.

According to the above-described sixth embodiment, in the case in which a plurality of interruption instruction codes 125 to 127 and a plurality of pieces of action information 171 to 173 exist, the number of interruptions for an interruption occurrence position can be obtained on each of the combinations of the interruption instruction codes and the pieces of action information. Furthermore, various interruption occurrence patterns can be investigated by generating the program interruption position information 181 to 184 based on the interruption instruction codes 125 to 127 and the pieces of action information 171 to 173.

While certain embodiments have been described, these embodiments have been presented by way of example only, and are not intended to limit the scope of the present invention. The novel embodiments can be implemented in a variety of other forms, and various omissions, substitutions, and changes can be made without departing from the spirit of the present invention. These embodiments and the modifications are included in the scope and spirit of the present invention and included in the scope of the invention described in the accompanying claims and their equivalents.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A program information generating system comprising circuitry configured to:
acquire a program including a non-interruption instruction code and an interruption instruction code, and action information indicating an order of execution of the non-interruption instruction code and the interruption instruction code;
determine an action interruption position representing a position where interruption has occurred in the action information based on the interruption instruction code and the action information;
determine a program interruption position representing a position where interruption has occurred in the program based on the non-interruption instruction code and the action interruption position; and
generate program interruption position information for specifying the program interruption position.

2. The program information generating system according to claim 1, wherein the circuitry is further configured to:
detect a coincident part coinciding with the interruption instruction code out of a plurality of instruction codes included in the action information;
detect an immediately preceding code positioned immediately ahead of the coincident part and an immediately following code positioned immediately behind the coincident part in the action information; and
determine a part having the immediately preceding code and the immediately following code successive in the non-interruption instruction code to be the program interruption position.

3. The program information generating system according to claim 2, wherein the program interruption position information includes instruction code specifying information that specifies the non-interruption instruction code corresponding to the immediately preceding code or the immediately following code out of the non-interruption instruction codes.

1. The program information generating system according to claim 3, wherein the program interruption position information further includes scope specifying information that specifies a scope including the immediately preceding code or the immediately following code out of a plurality of scopes in the program.

5. The program information generating system according claim 3, wherein the program interruption position information further includes interruption frequency information representing number of times executions of the interruption instruction code.

6. The program information generating system according to claim 3, wherein
the program includes a plurality of the interruption instruction codes; and
the program interruption position information is generated for each of the interruption instruction codes.

7. The program information generating system according to claim 3, wherein
the program includes a plurality of the interruption instruction codes;
the circuitry is further configured to acquire a plurality of pieces of the action information for each of the programs; and
the program interruption position information is generated for each combination of the action information and the interruption instruction code.

8. The program information generating system according to claim 1, wherein the circuitry further configured to:
designate a scope in the program;
determine the action interruption position in the designated scope; and
determine the program interruption position in the designated scope.

9. The program information generating system according to claim 1, wherein the circuitry further configured to:
control a display device to display a display image depicting a status of execution of the interruption instruction code based on the program interruption position information.

10. The program information generating system according to claim 9, wherein
the program interruption position information includes information that associates the program interruption position with interruption frequency representing number of times of executions of the interruption instruction code, and
the circuitry controls the display device to display the display image depicting the number of times of interruptions for each program interruption position based on the program interruption position information.

11. The program information generating system according to claim 10, wherein the circuitry controls the display device to display a field on the display image with the number of the times of interruptions satisfying a certain condition in a display form different from a display form for a field not satisfying the certain condition.

12. A program information generating method, comprising:
acquiring a program including a non-interruption instruction code and an interruption instruction code and action information indicating an order of execution of the non-interruption instruction code and the interruption instruction code;
determining an action interruption position representing a position where interruption has occurred in the action information based on the interruption instruction code and the action information;
determining a program interruption position representing a position where interruption has occurred in the program based on the non-interruption instruction code and the action interruption position; and
generating program interruption position information for specifying the program interruption position.

13. Program product having a non-transitory computer readable medium including a program, wherein the program, when executed by a computer, causes the computer to execute:
acquiring a program including a non-interruption instruction code and an interruption instruction code and action information indicating an order of execution of the non-interruption instruction code and the interruption instruction code;
determining an action interruption position representing a position where interruption has occurred in the action information based on the interruption instruction code and the action information;
determining a program interruption position representing a position where interruption has occurred in the program based on the non-interruption instruction code and the action interruption position; and
generating program interruption position information for specifying the program interruption position.
